(19) United States
(12) Patent Application Publication
(10) Pub. No.: US 2009/0123165 A1
(43) Pub. Date: May 14, 2009

(54) Dispersion compensating apparatus

(75) Inventors: Naoki Hashimoto, Kawasaki (JP); Kohei Shibata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,173

(22) Filed: Aug. 25, 2008

(30) Foreign Application Priority Data
Nov. 13, 2007 (JP) 2007-294175

(51) Int. Cl. H04B 10/04

(52) U.S. Cl. 398/192

(57) ABSTRACT

A dispersion compensating apparatus compensates dispersion of an optical signal using reflection-type etalons. Each of the etalons reflects the optical signal and at least one etalon has, with respect to a group delay characteristic, a wavelength cycle and a finesse that are larger than those of the other etalons. Power supplies and temperature control units respectively shift, in terms of the wavelength, the group delay characteristics of the etalons.

### CROSS-REFERENCE TO RELATED APPLICATIONS

This application is based upon and claims the benefit of priority from the prior Japanese Patent Application No. 2007-294175, filed on Nov. 13, 2007, the entire contents of which are incorporated herein by reference.

### BACKGROUND OF THE INVENTION

1. Field of the Invention

The present invention relates to a dispersion compensating apparatus that compensates dispersion of an optical signal using etalons.

2. Description of the Related Art

In the transmission of an optical signal using an optical fiber, the propagating velocity of the light differs for each wavelength component. Therefore, degradation of the pulse waveform of the optical signal increases as the transmission distance of the optical signal increases. This phenomenon is referred to as “wavelength dispersion”. Wavelength dispersion is a significant obstacle that restricts transmission distance especially in recent optical communication systems that significantly increase the transmission speed of optical signals.

In a single mode fiber (SMF) used in an ordinary optical transmission system, wavelength dispersion of approximately 15 to 17 ps/nm/km occurs at a wavelength of approximately 1,550 nm, i.e., a C-band optical signal transmitted through a 100 km SMF is subject to wavelength dispersion of approximately 1,500 to 1,700 ps/nm.

A technique of recovering the original pulse waveform of an optical signal is referred to as “wavelength dispersion compensation (hereinafter, “dispersion compensation”) and is executed by providing wavelength dispersion to an optical signal that has been subjected to wavelength dispersion occurring in an optical transmission path, where the wavelength dispersion provided has a property that is an inverse of that of the wavelength dispersion occurring in the optical transmission path. For example, a dispersion compensating fiber (DCF) is used as a dispersion compensator to compensate dispersion of an optical signal.

A DCF is an optical fiber that is designed to have a wavelength dispersion having a property that is an inverse of that of the wavelength dispersion of an ordinary SMF, by employing a specific refractive index distribution. When long-distance optical signal transmission is executed, relay nodes are provided at regular intervals and DCFs are connected and, thereby, the total wavelength dispersion of an optical signal is suppressed as close to zero as possible.

To cope with the recent and drastically increasing demand for transmission capacity, the introduction of an ultra-high-speed optical transmission system having a speed of, for example, 40 Gb/s is sought. Meanwhile, to further increase the transmission capacity of optical transmission systems, the number of signals multiplexed together is also expanding in wavelength division multiplexing (WDM) transmission. To increase the number of channels multiplexed in WDM transmission, each of the wavelength spacing among channels is decreased.

In WDM, the signal bandwidth and the wavelength spacing necessary for securing the signal band depend on bit rate and the modulation scheme of the optical signal. Currently, common optical transmission systems have transmission speeds of 10 Gb/s and in such systems, an intensity modulation (ON/OFF modulation) scheme such as return-to-zero (RZ) or non-return-to zero (NRZ) is employed to modulate optical signals. A common wavelength spacing of such a 10 Gb/s system is 100 GHz (approximately 0.8 nm).

In contrast, in optical transmission systems of 40 Gb/s, the adoption of a phase modulation scheme such as differential phase shift keying (DPSK) or differential quadrature PSK (DQPSK) is progressing. As DPSK and DQPSK respectively enable high-speed transmission while suppressing the signal bandwidth, each enables high-density WDM transmission with narrow wavelength spacing.

However, even when DPSK or DQPSK is used, a signal bandwidth of a 40 Gb/s system is at least twice as large as that of an 10 Gb/s system. Therefore, depending on the modulation scheme, the wavelength spacing of a 40 Gb/s system may expand compared to that of 10 Gb/s system. As described above, the band of an optical signal expands in a high bit rate optical transmission system and, therefore, resistance against wavelength dispersion further becomes lower compared to that obtained so far. Therefore, it is considered that even slight fluctuation of wavelength dispersion caused by temperature variation, etc., must be compensated in a 40 Gb/s system.

In an optical transmission system of 40 Gb/s, to compensate a residual dispersion that a dispersion compensating fiber can not completely compensate, a scheme is likely to be employed that combines a dispersion compensating fiber whose magnitude of dispersion compensation is fixed, and a variable dispersion compensator whose magnitude of dispersion compensation is variable. In Japanese Patent Application Laid-Open Publication Nos. 2003-264505 and 2007-092631, a dispersion compensating apparatus is proposed that combines two reflection-type etalons respectively having different finesses (reflectance) as a small-sized variable dispersion compensator.

An etalon is a resonator (Fabry-Pérot resonator) configured by disposing two partially reflective films in parallel. Generally, an etalon is configured by forming partially reflective films respectively on both sides of a parallel plate. An etalon having one of the reflective films formed to be totally reflective is referred to as a “reflection-type etalon” (or “Gires-Tournois (GT) etalon”). Ideally, a reflection-type etalon functions as an all-pass filter from which all incident light beams are output.

The parallel plate sandwiched by the two reflective films functions as a resonating cavity in which an optical signal propagates between the two reflective films. By adjusting the thickness (or the refractive index) of the resonating cavity, the magnitude of dispersion compensation can be varied. Generally, when the optical path length of a resonator of an etalon is reduced, the free spectral range (FSR) of the etalon is increased and the band is expanded. On the other hand, when the reflectance of the partially reflective films of an etalon is increased, the peak of a curve characterizing the group delay of the etalon is raised and the magnitude of dispersion compensation is increased.

However, a problem exists with the conventional techniques in that, when the thickness of the resonating cavity in the etalon is reduced to expand the band, the magnitude of dispersion compensation decreases and, therefore, sufficient dispersion compensation can not be realized. On the other hand, when the reflectance of each partially reflective film of the etalon is increased to increase the magnitude of dispersion compensation, a problem arises in that the effective band becomes narrow and, therefore, high-speed optical transmission is not possible. Further, when the reflectance of each partially reflective film of an etalon is increased, loss of the optical signal increases caused by the reflection efficiency of the reflective films and the absorption of light by the material of the cavity.

With reference to FIG. 12, description is given for a conventional dispersion compensating apparatus that has two etalons disposed in series therein, each having an identical FSR (=100 GHz) and where each partially reflective film of one etalon has reflectance R of 2% and that of the other etalon has reflectance R of 7%. FIG. 12 is a graph indicating characteristics of group delay in a conventional dispersion compensating apparatus. In FIG. 12, the horizontal axis indicates wavelength nm of an optical signal, while the vertical axis indicates group delay ps of the optical signal. Group delay curves 1211 and 1212 respectively characterize group delay of the two etalons.

A combined group delay curve 1220 characterizes the group delay of an optical signal that has been reflected by each of the two etalons once, i.e., characterizes a combination of the group delays. A magnitude of dispersion compensation ps/nm provided to the optical signal can be represented by the amount of variation (slope) in combined group delay curve 1220. Reference numeral 1230 indicates a band of the dispersion compensation by the dispersion compensating apparatus. In this case, the band 1230 is only approximately 35 GHz centered about a grid wavelength (thick lines in the graph). Therefore, the dispersion compensating apparatus can not be applied to an optical signal of a 40 Gb/s system.

FIG. 13 is a graph of a variation of the combined group delay characteristics shown in FIG. 12. When the group delay curves 1211 and 1212 shown in FIG. 12 are respectively shifted in terms of the wavelength thereof by adjusting the thickness of the resonating cavity of each of the two etalons, the slope of the combined group delay curve 1220 varies within a range of approximately ±30 as shown in FIG. 13. That is, the variable range of the magnitude of dispersion compensation of the dispersion compensating apparatus is only within a range of approximately ±30 ps/nm in the band of 35 GHz; hence, no sufficient band and no sufficient dispersion compensation property can be obtained with the conventional dispersion compensating apparatus.

Description is given for a case where the FSR of each of the two etalons is increased to expand the band of the dispersion compensating apparatus. FIG. 14 is a graph of the group delay when the FSR is doubled with respect to that for FIG. 12. In FIG. 14, components identical to those shown in FIG. 12 are given identical reference numerals and description thereof is omitted. When the FSR of each of the etalons is doubled by halving the thickness of the resonating cavity of each of the etalons, the band 1230 expands to approximately 70 GHz; however, the amount of variation of the combined group delay curve 1220 becomes smaller.

More specifically, the amplitude of the group delay peak in each of the group delay curves 1211 and 1212 is halved by halving the thickness of the resonating cavity of each of the two etalons. The doubling of the FSR causes the group delay curves 1211 and 1212 to be elongated in the horizontal direction and the slope of each of the group delay characteristics is halved. As a result, the slope of the combined group delay curve 1220 becomes roughly equal to a quarter of its original amount. This means that the magnitude of dispersion compensation of the dispersion compensating apparatus also becomes approximately a quarter of its original amount.

FIG. 15 is a graph of a variation of the combined group delay characteristic shown in FIG. 14. When the group delay curves 1211 and 1212 shown in FIG. 14 are respectively shifted in terms of the wavelength, the slope of the combined group delay curve 1220 varies within a range of approximately ±10 as shown in FIG. 15. Therefore, the magnitude of dispersion compensation of the dispersion compensating apparatus can be tuned within a range of approximately ±10 ps/nm. In this manner, when the FSR of each etalon is increased to expand the band of the dispersion compensating apparatus, the magnitude of dispersion compensation and the range of variability thereof become smaller and, therefore, sufficient dispersion compensation can not be executed.

Description is given for a case where the magnitude of dispersion compensation is increased by increasing the reflectance of each of the two etalons. FIG. 16 is a graph indicating characteristics of the group delay when the reflectance of each of the partially reflective films of the etalons is increased to a fourfold value thereof, with respect to the case shown in FIG. 14 (reflectance of 2% and 7%). FIG. 17 is a graph indicating characteristics of the group delay when the reflectance is similarly increased to a fivefold value thereof, with respect to the case shown in FIG. 14. As shown in FIGS. 16 and 17, components identical to those shown in FIG. 12 are given identical reference numerals and description thereof is omitted.

FIG. 16 depicts the group delay when the reflectance R of the partially reflective films of the two etalons is increased to 8% and 28%, respectively. FIG. 17 depicts the group delay when the reflectance R of the partially reflective films of the two etalons is increased to 10% and 35%, respectively. As shown in FIGS. 16 and 17, the slope of the combined group delay curve 1220 is increased by increasing the reflectance R of each of the two etalons.

However, the linearity of the combined group delay curve 1220 is spoiled as the reflectance R is increased. In the examples above, the result shown in FIG. 16 is the limit for increasing the slope of the combined group delay curve 1220 while maintaining its linearity. The amount of variation of the combined group delay curve 1220 in this case is only approximately 20 ps/nm.

As described above, when the magnitude of dispersion compensation is increased by increasing the reflectance R of the etalon, the linearity of the combined group delay curve 1220 is lost and the band 1230 within which effective dispersion compensation can be executed becomes narrow. Further, when the reflectance R of the etalon is increased, multiple reflections of an optical signal in the resonating cavity increase and optical signal loss caused by the reflection and absorption becomes significant.

Description is given for a case where the magnitude of dispersion compensation is increased by increasing the number of etalons. FIG. 18 is a graph of the group delay when three etalons are used. As shown in FIG. 18, components identical to those shown in FIG. 12 are given identical reference numerals and description thereof is omitted. Here, the three etalons are disposed in series, all have the same FSR and respectively have the reflectance R of 10%, 20%, and 40%.

A group delay curve 1811 characterizes the group delay of an etalon that has the reflectance R of 10%. A group delay curve 1812 characterizes the group delay of an etalon that has the reflectance R of 20%. A group delay curve 1813 characterizes the group delay of an etalon that has the reflectance R of 40%. A combined group delay curve 1820 characterizes a combination of the group delays 1811 to 1813.

In this case, the slope of the combined group delay curve 1820 varies within a range of approximately ±30 ps/nm. Therefore, the magnitude of dispersion compensation of the dispersion compensating apparatus varies within a range of approximately ±30 ps/nm. A band 1230 spanning approximately 70 GHz can be secured. However, the reflectance R of each of the etalons necessary for securing the magnitude of dispersion compensation and the band is large, such as 10%, 20%, and 40% respectively, for the etalons. Therefore, the optical signal loss caused by multiple reflections becomes significantly large.

As shown in FIGS. 12 to 18, in a dispersion compensating apparatus using etalons, a problem arises in that there is a trade-off between the band and the magnitude of dispersion compensation. Furthermore, when the reflectance R of a partially reflective film of an etalon is increased, a problem arises in that optical signal loss caused by the multiple reflections becomes large.

### SUMMARY OF THE INVENTION

It is an object of the present invention to at least solve the above problems in the conventional technologies.

A dispersion compensating apparatus according to one aspect of the present invention compensates dispersion of an optical signal using reflection-type etalons and includes plural etalons that include a first etalon, at least one, that reflects the optical signal; a second etalon, at least one, that reflects the optical signal and has, with respect to a group delay characteristic, a Free Spectral Range (FSR) and a finesse that are respectively larger than the FSR and the finesse of the first etalon; and a shifting unit that shifts, in terms of wavelength, the group delay characteristic of at least one of the etalons.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is schematic depicting a configuration of a dispersion compensating apparatus according to a first embodiment;

FIG. 2 is a graph indicating group delay characteristics of an ordinary etalon;

FIG. 3 is a graph indicating the group delay characteristics of each etalon according to the first embodiment;

FIG. 4 is a graph of a variation of the combined group delay characteristic shown in FIG. 3;

FIG. 5 is a graph indicating characteristics of a maximum compensation amount against the number of reflections;

FIG. 6 is another graph indicating the characteristics of the maximum compensation amount against the number reflections;

FIG. 7 is a schematic depicting a configuration of a dispersion compensating apparatus according to a second embodiment;

FIG. 8 is a graph indicating the group delay characteristics for each etalon according to the second embodiment;

FIG. 9 is a schematic depicting a configuration of a dispersion compensating apparatus according to a third embodiment;

FIG. 10 depicts a configuration of a dispersion compensation apparatus according to a fourth embodiment;

FIG. 11 is a schematic depicting a configuration of a dispersion compensation apparatus according to a fifth embodiment;

FIG. 12 is a graph indicating characteristics of group delay in a conventional dispersion compensating apparatus;

FIG. 13 is a graph of a variation of the combined group delay characteristics shown in FIG. 12;

FIG. 14 is a graph of the group delay when FSR is doubled with respect to that for FIG. 12;

FIG. 15 is a graph of a variation of the combined group delay characteristic shown in FIG. 14;

FIG. 16 is a graph indicating characteristics of the group delay when the reflectance of each of the partially reflective films of the etalons is increased to a fourfold value with respect to the case shown in FIG. 14;

FIG. 17 is a graph indicating characteristics of the group delay when the reflectance is similarly increased to a fivefold value; and

FIG. 18 is a graph of the group delay when three etalons are used.

### DETAILED DESCRIPTION OF THE PREFERRED EMBODIMENTS

Referring to the accompanying drawings, exemplary embodiments according to the present invention are explained in detail below.

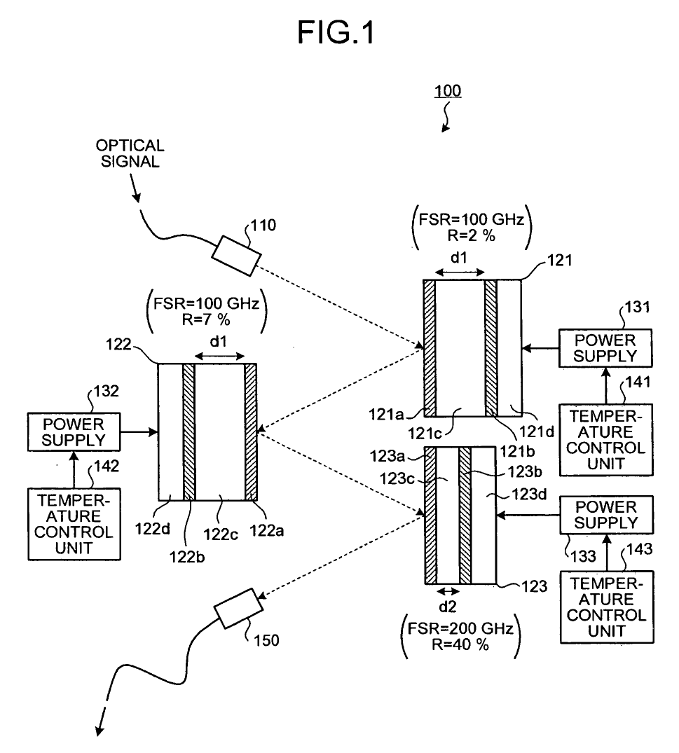

FIG. 1 is schematic depicting the configuration of a dispersion compensating apparatus according to a first embodiment. The dispersion compensating apparatus according to the first embodiment is one that compensates dispersion of an optical signal using reflection-type etalons. Description is given for a case where the dispersion compensating apparatus according to the first embodiment collectively compensates dispersion of channels of an optical signal that is wavelength-multiplexed at wavelength intervals of 200 GHz and that has a bit rate of 40 Gb/s (with the assumption that the band is approximately 70 GHz, which is roughly equal to ±0.3 nm in wavelength).

As shown in FIG. 1, a dispersion compensating apparatus 100 according to the first embodiment includes a collimator 110, etalons 121 to 123, power supplies 131 to 133, temperature control units 141 to 143, and a collimator 150. The collimator 110 collimates an optical signal input from an external source and transmits the optical signal to the etalon 121. The etalons 121 to 123 are reflection-type etalons that each impart a group delay for the optical signal that each etalon reflects, respectively.

The etalon 121 includes a partially reflective film 121a, a totally reflective film 121b, a resonating cavity 121c, and a Peltier element 121d. The partially reflective film 121a partially reflects at a predetermined reflectance R the optical signal transmitted from the collimator 110. An optical signal component not reflected by the partially reflective film 121a passes through the partially reflective film 121a. The totally reflective film 121b totally reflects the optical signal component that passes through the partially reflective film 121a.

The resonating cavity 121c is formed between the partially reflective film 121a and the totally reflective film 121b. The resonating cavity 121c imparts a group delay with respect to the light beam multi-reflected between the partially reflective film 121a and the totally reflective film 121b corresponding to the thickness (optical thickness) of the resonating cavity 121c. The Peltier element 121d varies the temperature of the etalon 121 corresponding to the electric power supplied from the power supply 131. The Peltier element 121d is joined to the totally reflective film 121b on a side that is opposite to the side adjoined to the resonating cavity 121c.

The etalon 122 includes a partially reflective film 122a, a totally reflective film 122b, a resonating cavity 122c, and a Peltier element 122d. The etalon 123 includes a partially reflective film 123a, a totally reflective film 123b, a resonating cavity 123c, and a Peltier element 123d. The components of each of these etalons 122 and 123 are identical the partially reflective film 121a, the totally reflective film 121b, the resonating cavity 121c, and the Peltier element 121d of the etalon 121 and description thereof is omitted.

The etalons 121 and 122 are first etalons that reflect an optical signal. The etalon 121 reflects the optical signal transmitted from the collimator 110 and transmits the optical signal to the etalon 122. The etalon 122 reflects the optical signal transmitted from the etalon 121 and transmits the optical signal to the etalon 123.

A thickness d of the resonating cavity 121c of the etalon 121 and that of the resonating cavity 122c of the etalon 122 are both “d1”. Therefore, the etalons 121 and 122 have the same group delay peak period (FSR). In this case, the FSR of the etalons 121 and 122 is 100 GHz, which is a half of the wavelength interval (200 GHz) of the optical signal.

The etalons 121 and 122 differ in the reflectance R of the partially reflective films respectively thereof. Therefore, the etalons 121 and 122 differ in finesses. In this case, the reflectance R of the partially reflective film 121a of the etalon 121 is 2% and that of the partially reflective film 122a of the etalon 122 is 7%.

The etalon 123 is a second etalon having an FSR and a finesse that are larger than those of the etalons 121 and 122. The etalon 123 reflects the optical signal transmitted from the etalon 122 and transmits the optical signal to the collimator 150. The FSR of the etalon 123 can be increased to be larger than that of the etalons 121 and 122 by reducing the thickness “d” of the resonating cavity 123c of the etalon 123 to be smaller than that of the resonating cavities 121c and 122c of the etalons 121 and 122.

In the embodiment, by setting the thickness d of the resonating cavity 123c to be d2 (d2=d1/2), the FSR of the etalon 123 is set to be twice as large as that of the etalons 121 and 122 (200 GHz), which is identical to the wavelength interval of the optical signal). By setting the reflectance R of the partially reflective film 123a of the etalon 123 to be larger than that of the etalons 121 and 122, the finesse of the etalon 123 can be made larger than that of the etalons 121 and 122. In the embodiment, the reflectance R of the partially reflective film 123a is 40%.

The collimator 150 outputs the optical signal transmitted from the etalon 123 to an external destination. The power supplies 131 to 133 and the temperature control units 141 to 143 form a shifting unit that shifts, in terms of the wavelength, group delay characteristics of the etalons 121 to 123, respectively. The power supply 131 supplies electric power, according to the control of the temperature control unit 141, to the Peltier element 121d. The power supply 132 supplies electric power, according to the control of the temperature control unit 142, to the Peltier element 122d. The power supply 133 supplies electric power, according to the control of the temperature control unit 143, to the Peltier element 123d.

The temperature control unit 141 controls the temperature of the etalon 121 by adjusting the electric power to be supplied to the Peltier element 121d by controlling the power supply 131. The temperature control unit 142 controls the temperature of the etalon 122 by adjusting the electric power to be supplied to the Peltier element 122d by controlling the power supply 132. The temperature control unit 143 controls the temperature of the etalon 123 by adjusting the electric power to be supplied to the Peltier element 123d by controlling the power supply 133.

The temperature control units 141 to 143 execute temperature control respectively of the etalons 121 to 123. When the temperature of each of the resonating cavities 121c to 123c of the etalons 121 to 123 is varied, respectively, the optical thickness (n×d) of each of the resonating cavities 121c to 123c is varied. Thereby, group delay characteristics respectively of the etalons 121 to 123 can be shifted in the wavelength direction.

FIG. 1 depicts the optical signal as if the optical signal transmitted from the collimator 110 is reflected by the etalons 121 to 123 remaining as a collimated light beam. However, the optical signal is multi-reflected on the resonating cavities 121c to 123c of the etalons 121 to 123. Therefore, in practice, the optical signal gradually diverges each time the optical signal is reflected by each of the etalons 121 to 123.

Description has been given for a case where the power supplies 131 to 133 and the temperature control units 141 to 143 control the thickness d of all of the resonating cavities 121c to 123c of the etalons 121 to 123. However, to vary the combined group delay characteristics of the etalons 121 to 123, the thickness d of at least one resonating cavity of the etalons 121 to 123 only needs to be controlled. For example, when the thickness d of only the resonating cavity 121c of the etalon 121 is controlled, the configuration may omit the power supplies 132 and 133 and the temperature control units 142 and 143.

The description has been given for a case where the power supplies 131 to 133 and the temperature control units 141 to 143 control the thickness d of each of the resonating cavities 121c to 123c of the etalons 121 to 123 and, thereby, the group delay characteristics are shifted in terms of the wavelength. However, the group delay characteristics may by shifted in terms of the wavelength by controlling the angle of incidence at which the optical signal enters at least one of the etalons 121 to 123.

Description has been given for a case where the temperature of each of the resonating cavities 121c to 123c is varied by providing the Peltier elements 121d to 123d to control the thickness d of each of the resonating cavities 121c to 123c. However, the apparatus may also be adapted to be provided with a heater instead of each of the Peltier elements 121d to 123d and adapted to vary the temperature of each of the resonating cavities 121c to 123c using the heater.

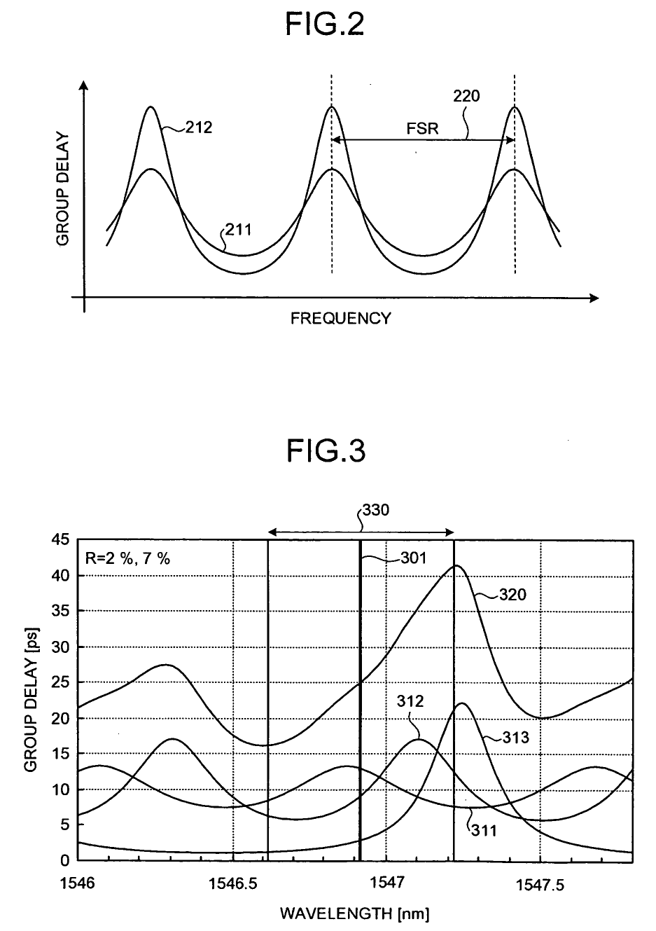

FIG. 2 is a graph indicating group delay characteristics of an ordinary etalon. In FIG. 2, the horizontal axis indicates the frequency of an optical signal (corresponding to the wavelength of the optical signal) and the vertical axis indicates the group delay of the optical signal. Description is given taking an example of the etalon 121 shown in FIG. 1. The group delay characteristic of an optical signal reflected by the etalon 121 is periodic for each frequency (wavelength) component thereof. The period of the group delay characteristic is determined by the thickness d of the resonating cavity (the cavity length) of the etalon.

The amplitude of the peak of the group delay characteristic increases as the reflectance R of the partially reflective film 121a of the etalon 121 becomes larger. A group delay curve 211 represents the group delay characteristic of an optical signal reflected by the etalon 121 having a reflectance R of 2%. A group delay curve 212 represents the group delay characteristic of an optical signal reflected by an etalon having a reflectance R that is higher than that of the etalon 121 (for example, the etalon 122, where R=7%).

The FSR of the etalon 121 is a frequency period 220 of the group delay curve 211. Expressing the thickness of the resonating cavity 121c of the etalon 121 as “d”, the refractive index of the material of the resonating cavity 121c as “n”, and the speed of light as “c”, the FSR of the etalon 121 can be expressed by the following equation (1).

$$FSR = \frac{c}{2 nd} \qquad ( 1 )$$

As expressed by equation (1), the FSR of the etalon 121 increases as the thickness d of the resonating cavity 121c decreases. Therefore, when the thickness of the resonating cavity 121c of the etalon 121 is varied, the group delay curve 211 is shifted in the frequency direction (wavelength direction).

The finesse of the etalon 121 is a parameter that represents the sharpness of the peak of the group delay curve 211 of the etalon 121. The finesse of the etalon 121 can be expressed by the following equation (2) using the reflectance R of the etalon 121.

$$Finesse = \frac{π \cdot \sqrt[4]{R}}{1 - R} \qquad ( 2 )$$

As expressed by equation (2), the finesse of the etalon 121 becomes larger and the spectrum of the group delay curve 211 of the etalon 121 becomes sharper as the reflectance R becomes larger.

FIG. 3 is a graph indicating the group delay characteristics of each etalon according to the first embodiment. In FIG. 3, the horizontal axis indicates the wavelength of an optical signal and the vertical axis indicates the group delay ps of the optical signal. A reference numeral 301 denotes a wavelength grid (the central wavelength of the optical signal) of the optical signal. In this case, the wavelength grid 301 is set at approximately 1,546.917 nm. Group delay curves 311 to 313 respectively represent the group delay characteristics of etalons 121 to 123.

A combined group delay curve 320 represents the group delay characteristic of an optical signal reflected once by each of the etalons 121 to 123. The combined group delay curve 320 is a curve obtained by combining the group delay curves 311 to 313. A magnitude of dispersion compensation ps/nm provided to the optical signal that is reflected once by each of the etalons 121 to 123 can be represented by the amount of variation (slope) in the combined group delay curve 320.

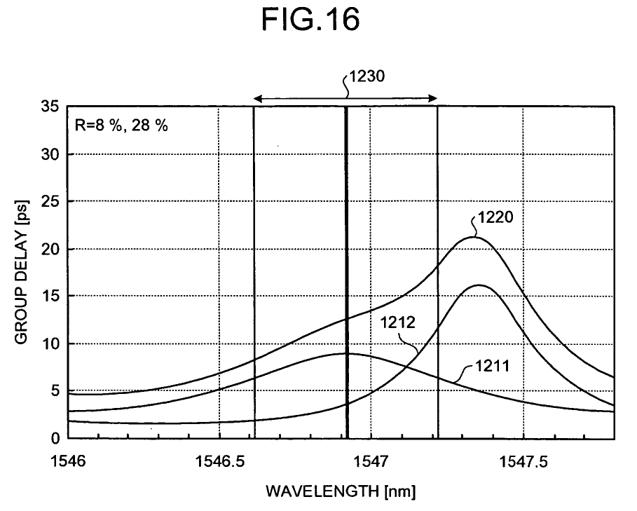

As can be seen from a comparison of FIGS. 3 and 16 (the case of a conventional type formed by combining two reflection-type etalons both having FSR=200 GHz and respectively having reflectance of 2% and 7%), according to the embodiment, the magnitude of compensation (or the variable range of compensation) of the dispersion compensating apparatus can be increased to a fourfold value.

The combined group delay curve 320 is adjusted by adequately shifting respectively the group delay curves 311 to 313 in terms of wavelength, using the temperature control units 141 to 143 such that the slope of the combined group delay curve 320 has a specific amount centered about the wavelength grid 301. A reference numeral 330 denotes a band of wavelength (approximately 1,546.6 to 1,547.2 nm) where the combined group delay curve 320 is roughly linear and the slope of the combined group delay curve 320 has the specific amount centered about the wavelength grid 301.

In the band 330, a group delay that is different for each wavelength component can be given to an optical signal. Therefore, the band 330 is the band within which the dispersion compensating apparatus 100 can execute adequate dispersion compensation. In the embodiment, the band 330 is approximately ±0.3 nm. Therefore, in this case, the band 330 of the dispersion compensating apparatus 100 is approximately 70 GHz.

In the embodiment, the FSR of each of the etalons 121 and 122 is set at 100 GHz, which is a half of the wavelength interval of the optical signal (200 GHz). The FSR of the etalon 123 is set at 200 GHz, which is identical to the wavelength interval of the optical signal. Therefore, the least common multiple of the FSRs of the etalons 121 to 123 is 200 GHz, which is identical to the wavelength interval of the optical signal. Hence, the combined group delay curve 320 has cyclicality that coincides with the wavelength spacing of the WDM optical signal.

For the combined group delay curve 320 to have cyclicality that coincides with the wavelength spacing of the optical signal: the ratio of the FSR of the etalons 121 and 122 to the FSR of the etalon 123 is not necessarily 1:2; the ratio of the FSR of the etalons 121, 122 and 123 only needs to be an integral ratio; and the common multiple of the FSRs of the all etalons substantially coincides with the wavelength spacing of the optical signal.

In particular, when FSR of the etalon 123 is set such that the FSR coincides with the wavelength spacing of the optical signal, a group delay having a specific slope can be provided for each channel of the optical signal. However, when it is not necessary to collectively compensate the dispersion of the channels of the optical signal, the ratio of the FSRs of the etalons 121 to 123 does not need to be an integral ratio and FSRs that can obtain a desired magnitude of dispersion compensation only need to be set.

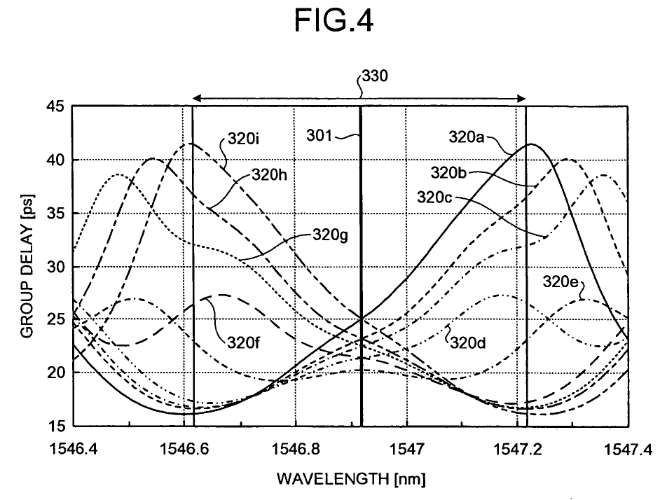

FIG. 4 is a graph of a variation of the combined group delay characteristic shown in FIG. 3. When the temperature control units 141 to 143 respectively adjust the optical thicknesses (n×d) respectively of the resonating cavities 121c to 123c, the group delay curves 311 to 313 shown in FIG. 3 respectively vary. Thereby, as shown in FIG. 4, the combined group delay curve 320 varies as combined group delay curves 320a to 320i indicate. The combined group delay curve 320a represents a characteristic having the maximum slope (magnitude of dispersion compensation) in the positive direction.

The magnitude of dispersion compensation for the combined group delay curve 320a is approximately 40 ps/nm. The combined group delay curve 320i represents a characteristic having the maximum slope in the negative direction. The magnitude of dispersion compensation in the combined group delay curve 320i is approximately −40 ps/nm. Therefore, when the optical signal is reflected once by each of the etalons 121 to 123, the magnitude of dispersion compensation can be varied within a range of approximately ±40 ps/nm in the band 330.

Although the graphs show only the portion about the wavelength of 1,546.917 nm, which is the wavelength grid 301, the combined group delay curve 320 has cyclicality that coincides with the wavelength spacing of the optical signal (200 GHz) as described above. Therefore, a group delay characteristic identical to that of the band 330 is also realized for each of the other wavelength grids arranged at intervals of 200 GHz, and identical dispersion compensation can be executed to optical signal components of each channel of a wavelength-multiplexed optical signal (colorless operation).

As described above, reflecting the optical signal once by each of the etalons 121 to 123 enables a magnitude of dispersion compensation of ±40 ps/nm to be obtained. However, reflecting the optical signal plural times by each of the etalons 121 to 123 (multiple-staged) the magnitude of dispersion compensation can be increased. For example, when the number reflections of the optical signal by each of the etalons 121 to 123 is set to be 10 (10 stages), the magnitude of dispersion compensation is at most ±400 ps/nm.

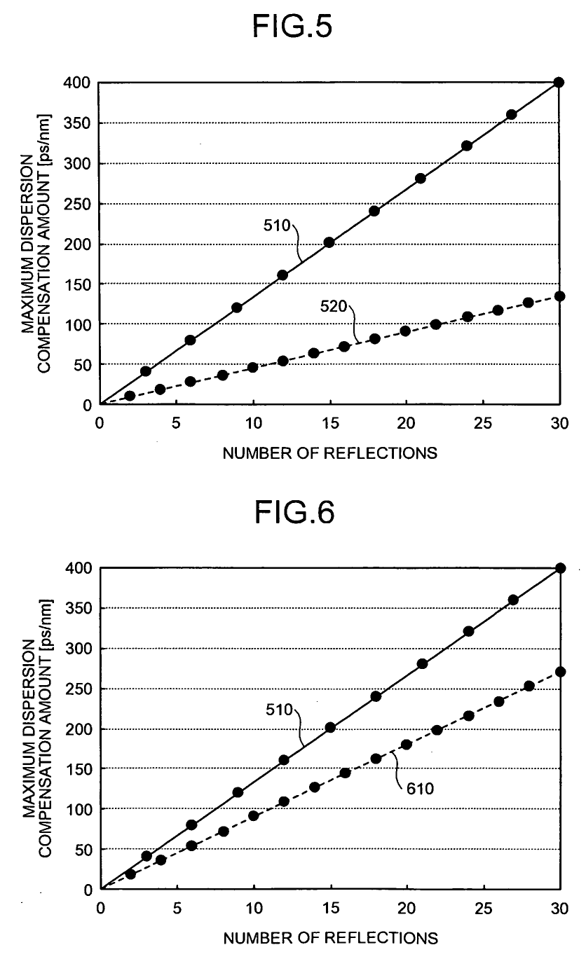

FIG. 5 is a graph indicating characteristics of the maximum compensation amount against the number of reflections. In FIG. 5, the horizontal axis indicates the number of reflections (the number of times) by the etalons 121 to 123 and the vertical axis indicates the maximum magnitude of dispersion compensation ps/nm for the optical signal. A curve 510 indicates the maximum magnitude of dispersion compensation obtained when two etalons having the FSR of 200 HGz (and respectively having the reflectance of 2% and 7%) and one etalon having the FSR of 100 GHz (and having the reflectance of 40%) are used as the dispersion compensating apparatus 100 shown in FIG. 1.

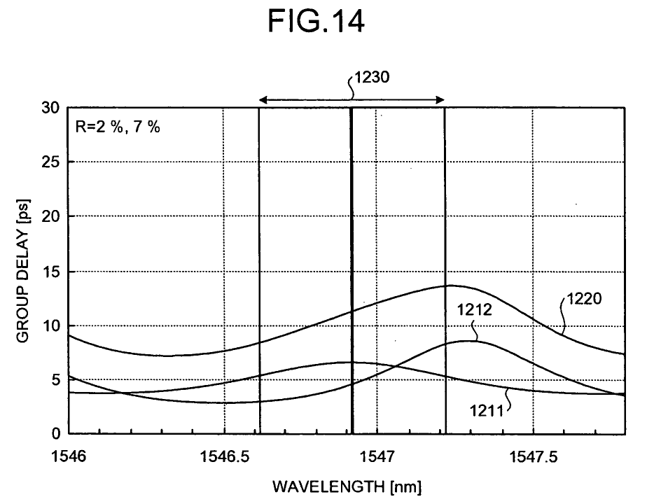

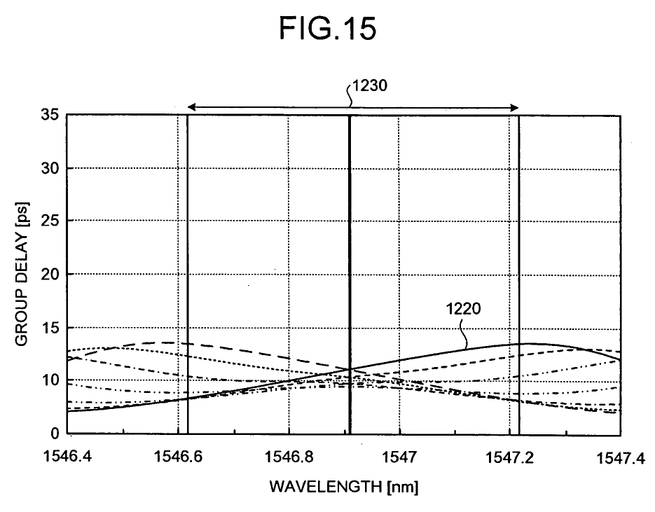

A curve 520 indicates the maximum magnitude of dispersion compensation obtained when only two etalons both having the same FSR (=200 GHz) (and respectively having the reflectance of 2% and 7%) are used (see FIGS. 14 and 15). Compared to a dispersion compensating apparatus using only two etalons both having the same FSR, the dispersion compensating apparatus 100, further including the etalon 123 having the FSR of 100 GHz, has three etalons and hence, the number of reflections of the optical signal for one stage is 3/2 times as great.

However, the dispersion compensating apparatus 100 has a magnitude of dispersion compensation that is (per one stage) four-folds that of a conventional dispersion compensating apparatus, which uses only two etalons both having the same FSR. Therefore, when the same magnitude of dispersion compensation is realized, the number of reflections of the optical signal in the dispersion compensating apparatus 100 is approximately ⅓ of that of the conventional dispersion compensating apparatus.

As described above, the dispersion compensating apparatus 100 requires a fewer number of reflections of the optical signal compared to that of the conventional dispersion compensating apparatus. Therefore, the dispersion compensating apparatus 100 can suppress optical signal loss caused by the multiple reflections on the etalons. In particular, when the magnitude of dispersion compensation is increased, the number of reflections of the optical signal can be significantly reduced and, therefore, an effect of suppressing optical signal loss is significant.

FIG. 6 is another graph indicating the characteristics of the maximum compensation amount against the number reflections. As shown in FIG. 6, components identical to those shown in FIG. 5 are given identical reference numerals and description thereof is omitted. A curve 610 indicates the maximum magnitude of dispersion compensation in a dispersion compensating apparatus (see FIG. 16) that uses an etalon having the FSR of 200 HGz and the reflectance R of 8% and an etalon having the FSR of 200 GHz and the reflectance R of 28%.

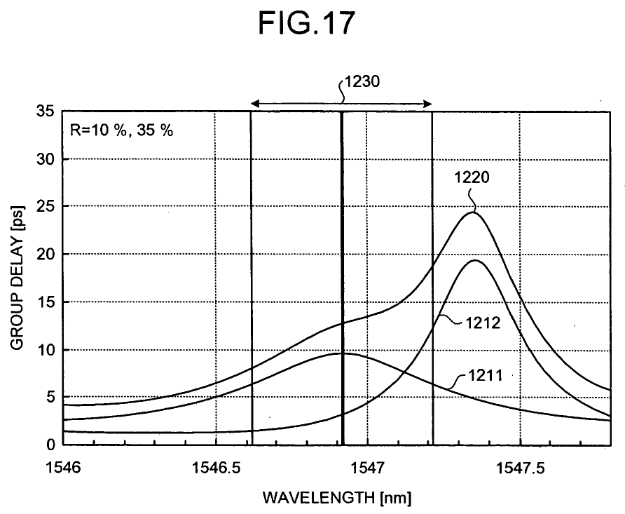

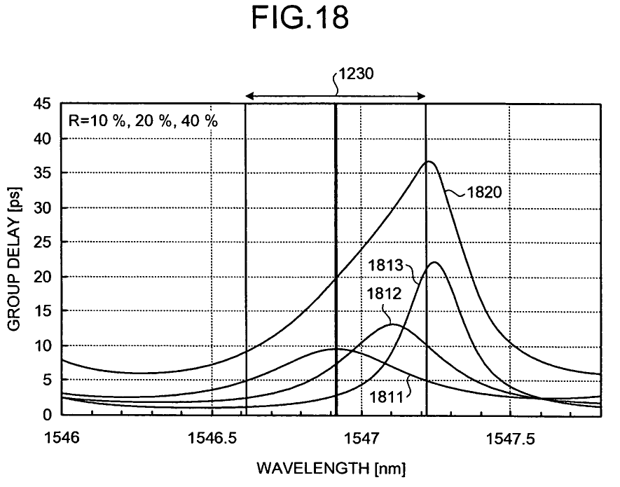

As indicated by the curve 610, even in a dispersion compensating apparatus that uses only two etalons having the same FSR, the magnitude of dispersion compensation can be increased to some extent by increasing the reflectance R of each etalon to 8% and 28%, respectively. However, to maintain the linearity of the combined group delay curve 320 in the band 330, the reflectance R of approximately 8% and approximately 28% are the upper limits for the etalons, respectively, as shown in FIGS. 16 and 17.

As indicated by the curves 510 and 610, the magnitude of dispersion compensation of the curve 610 is approximately ⅔ of that of the curve 510. Therefore, when an identical dispersion amount is realized, the number of reflections of the optical signal in the dispersion compensating apparatus 100 is approximately ⅔ of that of the dispersion compensating apparatus, which uses only two etalons both having the same FSR and high reflectance R.

As described above, the dispersion compensating apparatus 100 can reduce the number of reflections of the optical signal compared to a dispersion compensating apparatus, which uses only two etalons both having the same FSR and high reflectance R. Therefore, the apparatus 100 can suppress optical signal loss caused by the reflection on the etalons. Furthermore, the reflectance R of each of the etalons 121 to 123 can be decreased to obtain the necessary magnitude of dispersion compensation and, therefore, the apparatus 100 can reduce optical signal loss that occurs each time the optical signal is reflected by each of the etalons 121 to 123. Hence, the apparatus 100 can further suppress optical signal loss caused by reflection and absorption.

As described above, the dispersion compensating apparatus 100 according to the first embodiment can increase the magnitude of dispersion compensation without increasing the reflectance R of each etalon therein, by combining the etalons 121 and 122 with the etalon 123, which has a different FSR and finesse than that of the etalons 121 and 122. Therefore, the dispersion compensation characteristic of the apparatus 100 can be improved while securing sufficient band. Further as the magnitude of dispersion compensation of the dispersion compensation apparatus 100 can be increased without increasing the reflectance R of each of the etalons therein, optical signal loss caused by reflection and absorption can be suppressed.

The combined group delay curve 320 has periodicity that coincides with the wavelength spacing of the optical signal due to the settings executed such that the ratio of the FSR of the etalons 121 and 122 to the FSR of the etalon 123 is an integral ratio and the common multiple of the FSRs substantially coincides with the wavelength interval of the optical signal. Therefore, a colorless operation is enabled. The arrangement of the etalons is not limited to that shown in FIG. 1 and, provided the light beam sequentially passes through the three etalons, the order of passage therethrough is arbitrary.

Description has been given for a case where the etalons 121 and 122 are provided as the first etalons and the etalon 123 is provided as the second etalon having a larger FSR and a larger finesse than that of the first etalons. However, at least one first etalon and one second etalon only need to be provided. For example, for the configuration shown in FIG. 1, a configuration may be employed that omits the etalon 122 and that causes the optical signal reflected by the etalon 121 to enter the etalon 123.

Etalons each having an FSR and a finesse that are smaller than that of the etalon 123 may further be provided as a first etalon.

Description has been given above for a case where the etalon 123 is provided for a stage subsequent to the etalons 121 and 122. However, arrangement order of the etalons is arbitrary. For example, the etalon 123 may be provided for a stage immediately preceding the etalons 121 and 122 or the etalon 123 may be provided between the etalons 121 and 122.

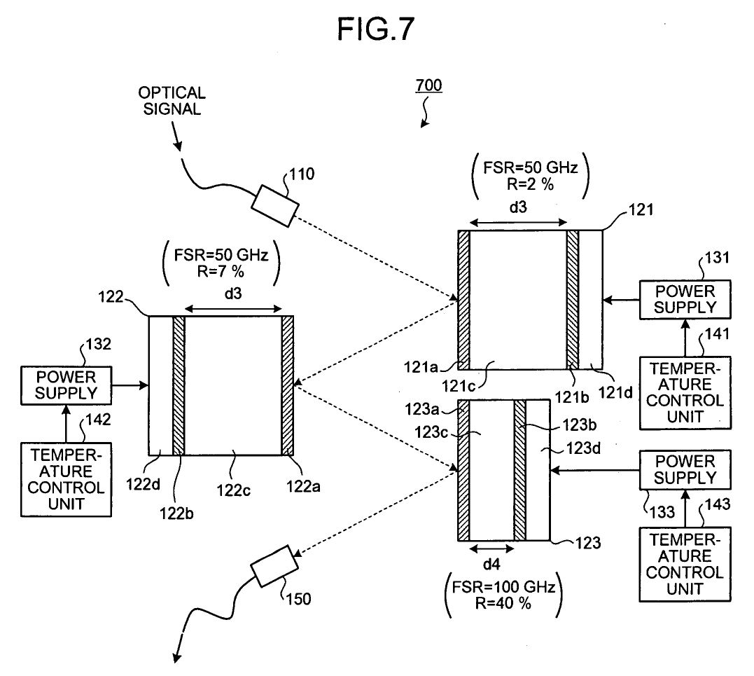

FIG. 7 is a schematic depicting a configuration of a dispersion compensating apparatus according to a second embodiment. As shown in FIG. 7, components identical to those shown in FIG. 1 are given identical reference numerals and description thereof is omitted. In the first embodiment, description has been given for a case where the magnitude of dispersion compensation is increased while the necessary band is maintained. However, when the band is narrowed, the magnitude of dispersion compensation can further be increased.

In a dispersion compensating apparatus 700 according to the second embodiment, the thickness d of each of the resonating cavities 121c and 122c of the etalons 121 and 122 is doubled to d3 (d3=2×d1) with respect to that in the dispersion compensating apparatus 100 according to the first embodiment (see FIG. 1). Thereby, the FSR of each of the etalons 121 and 122 is 50 GHz, which is a half of that of the first embodiment.

In addition, the thickness d of the resonating cavity 123c of the etalon 123 is doubled to d4 (d4=2×d2). Thereby, the FSR of the etalon 123 is 100 GHz, which is a half of that of the first embodiment. The reflectance R of each of the partially reflective films 121a to 123a of the etalons 121 to 123 is set to be 2%, 7%, and 40% respectively for the films similarly to those in the first embodiment.

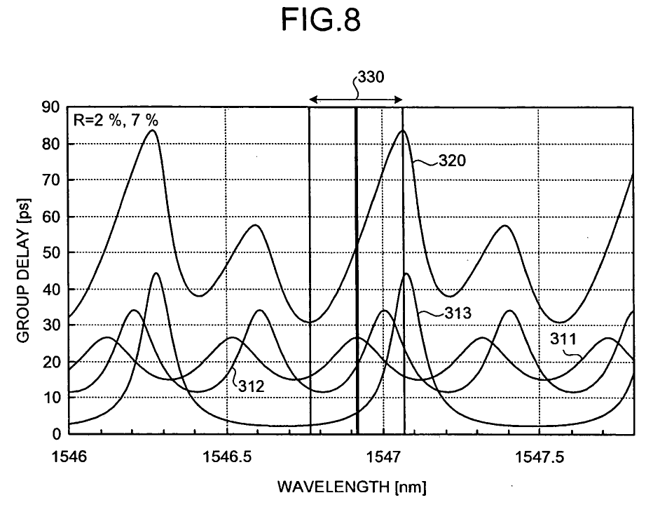

FIG. 8 is a graph indicating the group delay characteristics for each etalon according to the second embodiment. As shown in FIG. 8, components identical to those shown in FIG. 3 are given identical reference numerals and description thereof is omitted. As depicted in FIG. 8, the band 330 is approximately ±0.15 nm (approximately 1,546.8 to 1,547.1 nm). Therefore, the band 330 of the dispersion compensating apparatus 100 is approximately 35 GHz.

The combined group delay curve 320 represents the combined group delay characteristic having the maximum slope (magnitude of dispersion compensation) in the positive direction when the group delay curves 311 to 313 are appropriately shifted in terms of wavelength respectively using the temperature control units 141 to 143. The magnitude of dispersion compensation for the combined group delay curve 320 is 120 ps/nm.

The magnitude of dispersion compensation for the combined group delay curve 320 can be varied to −120 ps/nm by shifting in terms of wavelength the group delay curves 311 to 313 respectively using the temperature control units 141 to 143. Therefore, in the dispersion compensating apparatus 700, when the optical signal is reflected once by each of the etalons 121 to 123, the magnitude of dispersion compensation can be varied within a range of approximately ±120 ps/nm in the band 330.

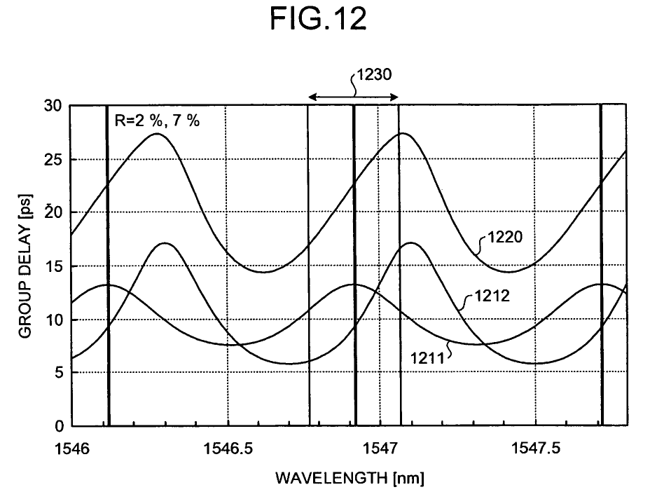

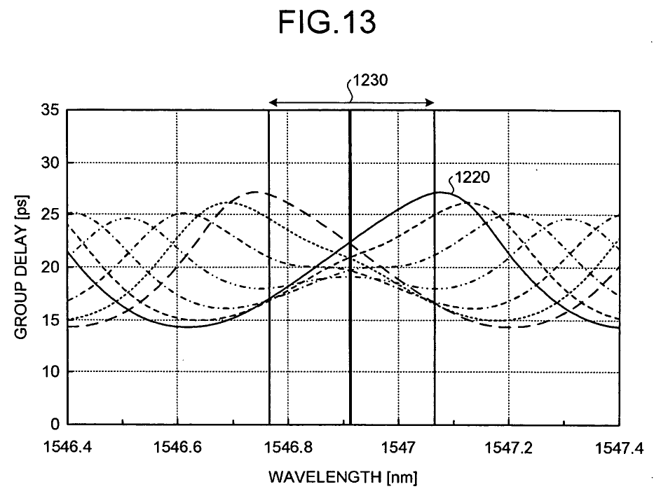

As described above, the dispersion compensating apparatus 700 enables the magnitude of dispersion compensation to be increased without narrowing the band compared to the case of the conventional configuration of FIG. 12, where the thickness d of each of the resonating cavities 121c to 123c of the etalons 121 to 123 is increased. As shown with the first and the second embodiments, the trade-off between the band and the magnitude of dispersion compensation can be overcome by combining plural etalons that respectively have different FSRs and finesses.

For example, both the band and the magnitude of dispersion compensation can be improved simultaneously as illustrated by the first embodiment. Further, the magnitude of dispersion compensation can be improved significantly when the thickness d of each of the resonating cavities 121c to 123c of the etalons 121 to 123 is increased, as illustrated by the second embodiment. The band can also be improved significantly when the thickness d of each of the resonating cavities 121c to 123c of the etalons 121 to 123 is reduced.

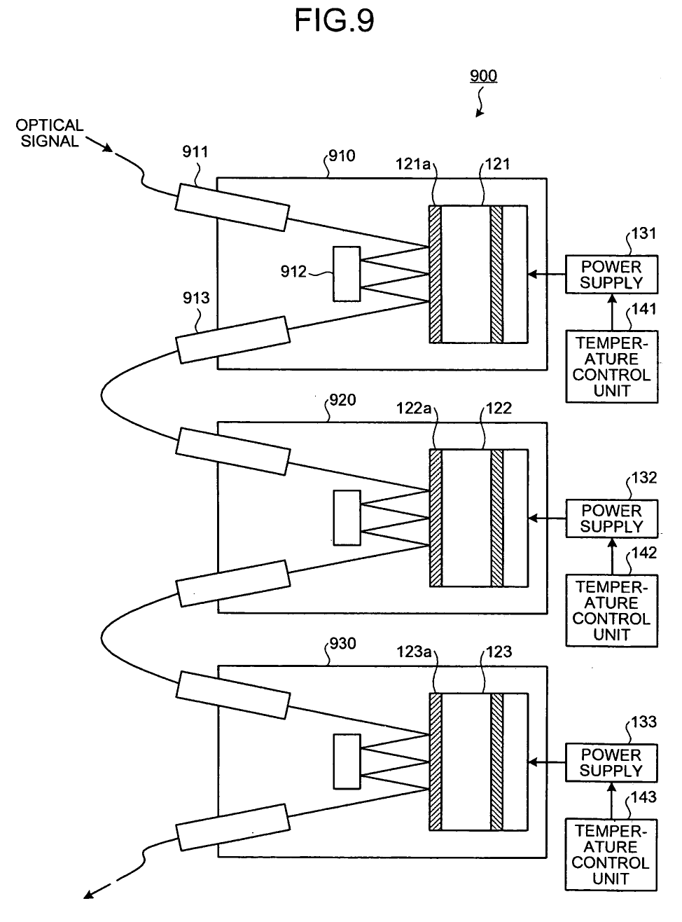

FIG. 9 is a schematic depicting a configuration of a dispersion compensating apparatus according to a third embodiment. As shown in FIG. 9, components identical to those shown in FIG. 1 are given identical reference numerals and description thereof is omitted. A dispersion compensating apparatus 900 according to the third embodiment includes modules 910, 920, and 930, the power supplies 131 to 133, and the temperature control units 141 to 143.

The module 910 includes a collimator 911, the etalon 121, a totally reflective mirror 912, and a collimator 913 enclosed within a housing. The collimator 911 transmits to the partially reflective film 121a of the etalon 121 an optical signal that is input from an external source. The totally reflective mirror 912 is disposed in parallel to and opposing the etalon 121.

The optical signal transmitted to the etalon 121 is reflected plural times between the etalon 121 and the totally reflective mirror 912 and the optical signal is transmitted to the collimator 913. The collimator 913 outputs to the module 920 the optical signal transmitted thereto. The reflectance R of the partially reflective film 121a of the etalon 121 is 2% and the FSR of the etalon 121 is 100 GHz.

The modules 920 and 930 also each have an identical configuration to that of the module 910. However, the reflectance R of the partially reflective film 122a of the etalon 122 of the module 920 is 7% and the FSR thereof is 100 GHz. The reflectance R of the partially reflective film 123a of the etalon 123 of the module 930 is 40% and the FSR thereof is 200 GHz. The module 920 reflects the optical signal, output from the module 910, between the etalon 122 and the totally reflective mirror plural times and the module 920 outputs the optical signal to the module 930.

The module 930 reflects the optical signal, output from the module 920, between the etalon 123 and the totally reflective mirror plural times and the module 930 outputs the optical signal to an external destination. The etalons 121 to 123 are connected respectively to the power supplies 131 to 133 and the temperature control units 141 to 143. The power supplies 131 to 133 and the temperature control units 141 to 143 respectively control the temperatures of the etalons 121 to 123 similarly to the configuration shown in FIG. 1.

As described above, the dispersion compensating apparatus 900 according to the third embodiment realizes the effect of the dispersion compensating apparatus 100 and, by combining the etalons 121 to 123 each respectively incorporated in a module, the combination of the etalons respectively having different FSRs and finesses can be easily changed. Therefore, the band and the magnitude of dispersion compensation can be easily adjusted corresponding to the characteristics of the optical signal.

In the module 910, by reflecting the optical signal plural times between the totally reflective mirror 912 and the etalon 121, the dispersion compensation can be adapted to be multi-staged in the one module. The same is true for the modules 920 and 930. Therefore, the magnitude of dispersion compensation can be increased while facilitating downsizing of the apparatus by reducing the number of etalons.

Description has been given for a case where the optical signal is reflected plural times by providing a totally reflective mirror (for example, the totally reflective mirror 912) for each of the etalons 121 to 123. However, to reduce the number of etalons to secure a required magnitude of dispersion compensation, the optical signal merely needs to be reflected plural times by providing a totally reflective mirror for at least one of the etalons 121 to 123.

Further, the number reflections of the optical signal by each of the etalons 121 to 123 may be separately adjusted. Thereby, the characteristics the dispersion compensation by the etalons 121 to 123 can be varied. For example, to adjust the number reflections of the optical signal by the etalon 121, the distance between the etalon 121 and the totally reflective mirror 912, the angle formed by the etalon 121 and the totally reflective mirror 912, and/or the angle at which the optical signal enters each of the etalons 121 to 123 are varied. Further, the width of the partially reflective film 121a of the etalon 121 and/or that of the totally reflective mirror 912 may be varied.

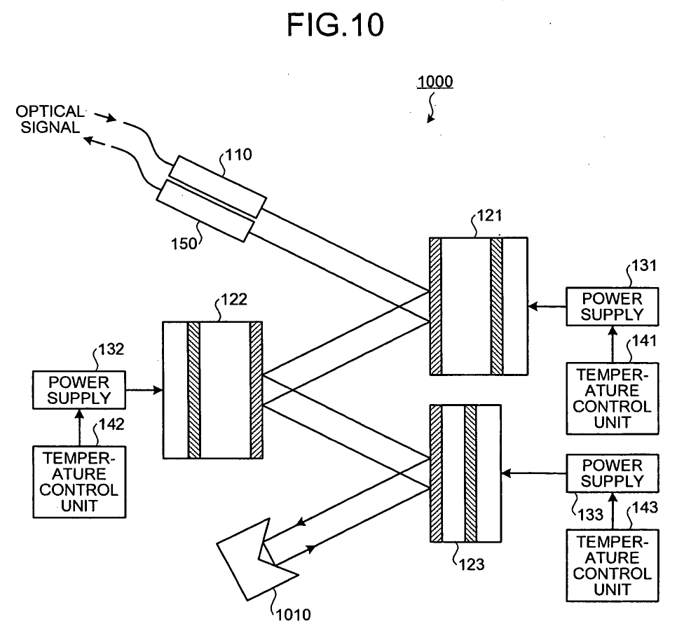

FIG. 10 depicts a configuration of a dispersion compensation apparatus according to a fourth embodiment. As shown in FIG. 10, components identical to those shown in FIG. 1 are given identical reference numerals and description thereof is omitted. As shown in FIG. 10, a dispersion compensating apparatus 1000 according to the fourth embodiment includes the collimator 110, the etalons 121 to 123, a returning mirror 1010, the power supplies 131 to 133, the temperature control units 141 to 143, and the collimator 150.

An optical signal is transmitted from the collimator 110, is reflected by each of the etalons 121 and 122, and by the etalon 123. The optical signal is transmitted to the returning mirror 1010. The returning mirror 1010 reflects and returns the optical signal transmitted from the etalon 123 in a path in parallel to the incident optical path. The optical signal returned by the returning mirror 1010 is again reflected by each of the etalons 123, 122, and 121 in this sequence and is transmitted to the collimator 150. The collimator 150 outputs, to an external destination, the optical signal transmitted from the etalons 121 to 123.

Thereby, the dispersion compensation can be adapted to be multi-staged by increasing the number reflections of the optical signal by the etalons 121 to 123. The returning mirror 1010 is, for example, a corner cube prism or a retro-reflector. The dispersion compensation may be adapted to be further multi-staged by providing a mirror that returns the optical signal to the etalon 121 to be reflected again by the etalons 121 to 123.

As described above, the dispersion compensating apparatus 1000 according to the fourth embodiment realizes the effect of the dispersion compensating apparatus according to the first and the second embodiments and, by returning the optical signal reflected by the etalons 121 to 123, enables the optical signal to be reflected again by the etalons 121 to 123; and hence, dispersion compensation can be adapted to multi-staged. Therefore, the magnitude of dispersion compensation can be increased while facilitating downsizing of the apparatus by reducing the number of the etalons.

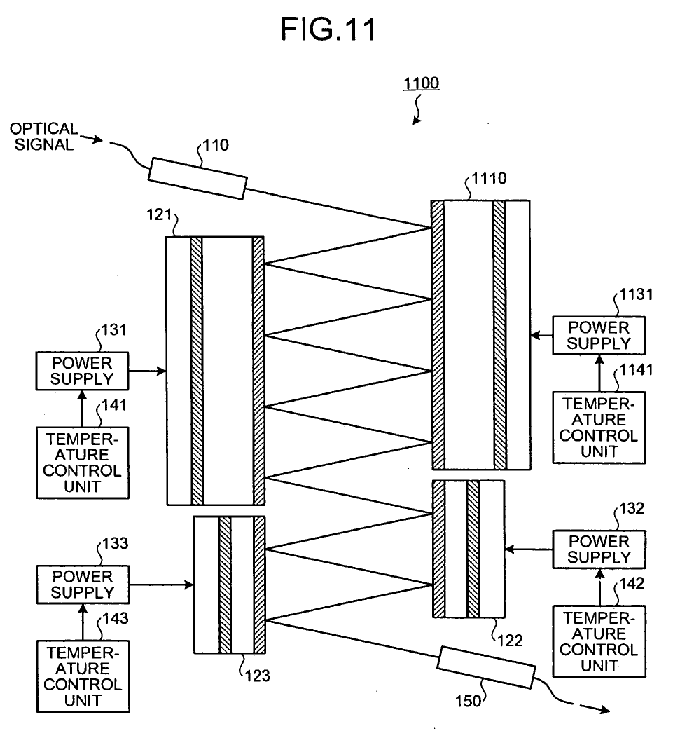

FIG. 11 is a schematic depicting a configuration of a dispersion compensation apparatus according to a fifth embodiment. As shown in FIG. 11, components identical to those shown in FIG. 1 are given identical reference numerals and description thereof is omitted. As shown in FIG. 11, a dispersion compensating apparatus 1100 according to the fifth embodiment includes the collimator 110, an etalon 1110, the etalons 121 to 123, the power supplies 131 to 133 and 1131, the temperature control units 141 to 143 and 1141, and the collimator 150.

The collimator 110 transmits to the etalon 1110 an optical signal input from an external source. The etalon 1110 is a first etalon having an FSR and finesse that are smaller than those of the etalon 123. The etalons 1110 and 121 are disposed opposing each other. The optical signal transmitted from the collimator 110 to the etalon 1110 is reflected plural times between the etalons 1110 and 121 (in this case, each reflects the optical signal four times) and the optical signal is transmitted to the etalon 122.

The etalons 122 and 123 are disposed opposing each other. The optical signal reflected plural times between the etalons 1110 and 121 is reflected again plural times between the etalons 122 and 123 (in this case, each reflects the optical signal twice) and the optical signal is transmitted to the collimator 150. The collimator 150 outputs, to an external destination, the optical signal reflected plural times between the etalons 122 and 123. The power supply 1131 and the temperature control unit 1141 respectively have identical configurations to those of the power supply 131 and the temperature control unit 141 and control the temperature of the etalon 1110.

In the embodiment, the number reflections of the optical signal by the etalons 1110 and 121 is increased by increasing the width of the partially reflective films respectively of the etalons 122 and 123. The optical signal is caused to obliquely enter the etalon 1110 by disposing the etalons 121 to 123 and 1110 in parallel. In this case, the polarization dependency on the reflectance of the optical signal can be suppressed by setting the angle of incidence of the optical signal to the etalon 1110 at approximately one to two degrees.

As described above, the dispersion compensating apparatus 1100 according to the fifth embodiment realizes the effect of the dispersion compensating apparatus according to the first and the second embodiments and, by disposing the etalons 121 to 123 and 1110 in pairs opposing each other and by causing the optical signal to be reflected plural times between each pair of opposed etalons, dispersion compensation can be adapted to be multi-staged. Therefore, the magnitude of dispersion compensation can be increased while facilitating downsizing of the apparatus by reducing the number of the etalons.

Description has been given for a case where the optical signal is reflected plural times by each of the etalons 121 to 123 and 1110. However, when the optical signal is reflected plural times by at least two of the etalons 121 to 123 and 1110, dispersion compensation can be adapted to be multi-staged. Further, the number reflections of the optical signal by each of the etalons 121 to 123 and 1110 may separately be adjusted. Thereby, the characteristics of the dispersion compensation by the dispersion compensating apparatus 1100 can be varied.

As described above, the embodiment enables improvement of the band and the dispersion compensation characteristics while suppressing optical signal loss.

According to the embodiments, the magnitude of dispersion compensation can be increased without increasing the reflectance of each etalon, by combining etalons that respectively have different FSRs and different finesses with respect to the group delay characteristics. Therefore, dispersion compensation characteristics can be improved while securing a sufficient band. Because the magnitude of dispersion compensation can be increased without increasing the reflectance of each etalon, optical signal loss caused by multiple reflections can be suppressed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A dispersion compensating apparatus that compensates dispersion of an optical signal using reflection-type etalons, comprising:
a plurality of etalons that include
a first etalon, at least one, that reflects the optical signal;
a second etalon, at least one, that reflects the optical signal and has, with respect to a group delay characteristic, a FSR and a finesse that are respectively larger than the FSR and the finesse of the first etalon; and
a shifting unit that shifts, in terms of wavelength, the group delay characteristic of at least one of the etalons.

2. The dispersion compensating apparatus according to claim 1 comprising a plurality of the first etalons having, with respect to group delay characteristics, identical FSRs and differing finesses.

3. The dispersion compensating apparatus according to claim 1, wherein
the optical signal is a wavelength-multiplexed signal, and
the FSR of the second etalon is equal to a wavelength interval of the optical signal.

4. The dispersion compensating apparatus according to claim 3, wherein
a ratio of the FSR of the first etalon to the FSR of the second etalon is an integral ratio.

5. The dispersion compensating apparatus according to claim 1, wherein
the etalons each include a resonating cavity, respectively, and
the shifting unit varies a thickness of at least one of the resonating cavities to shift, in terms of wavelength, the group delay characteristic.

6. The dispersion compensating apparatus according to claim 5, wherein
the shifting unit controls a temperature of the resonating cavity for which the thickness is varied to vary an optical thickness of the resonating cavity for which the thickness is varied.

7. The dispersion compensating apparatus according to claim 1, wherein
the etalons each include a partially reflective film, respectively, and
the shifting unit varies an angle of incidence of the optical signal into at least one of the partially reflective films.

8. The dispersion compensating apparatus according to claim 1, further comprising:
a reflecting unit that is disposed opposing at least one of the etalons and reflects the optical signal plural times to the etalon opposing the reflecting unit.

9. The dispersion compensating apparatus according to claim 1, further comprising:
a returning unit that returns, to the etalons, the optical signal that has been reflected by the etalons, to cause the etalons to reflect again the optical signal.

10. The dispersion compensating apparatus according to claim 1, wherein
at least two of the etalons are disposed opposing each other and reflect the optical signal therebetween a plurality of times.
